(19) United States
(12) Patent Application Publication
(10) Pub. No.: US 2017/0090904 A1
(43) Pub. Date: Mar. 30, 2017

(54) APPLICATION MANAGEMENT DEVICE, APPLICATION MANAGEMENT METHOD, AND COMPUTER-READABLE RECORDING MEDIUM

(71) Applicant: FUJITSU LIMITED, Kawasaki-shi (JP)

(72) Inventors: Kazuya SHIDA, Yokohama (JP); Kazunori Kobashi, Yamato (JP); Tetsuya Nishimura, Yokohama (JP); Hideki Sakurai, Kawasaki (JP); Koyo Miyagi, Ota (JP); Tadahiro Kageyama, Kawasaki (JP)

(73) Assignee: FUJITSU LIMITED, Kawasaki-shi (JP)

(21) Appl. No.: 15/242,995

(22) Filed: Aug. 22, 2016

(30) Foreign Application Priority Data
Sep. 24, 2015 (JP) 2015-187466

(51) Int. Cl. G06F 9/445

(52) U.S. Cl. CPC G06F 8/65

(57) ABSTRACT

An application management device includes a memory that stores therein application conditions for defining a condition of whether an update program is to be applied to a data center. The application management device acquires information for an update program from a control center that manages failures in a plurality of data centers including the data center. Thereafter, the application management device controls the application of the update program to the data center based on the acquired information for the update program and the stored application conditions.

### CROSS-REFERENCE TO RELATED APPLICATION

This application is based upon and claims the benefit of priority of the prior Japanese Patent Application No. 2015-187466, filed on Sep. 24, 2015, the entire contents of which are incorporated herein by reference.

### FIELD

The embodiments discussed herein are related to an application management device, an application management method, and an application management program.

### BACKGROUND

In recent years, with the spread of cloud computing, business operators using resources of a plurality of data centers (hereinafter, sometimes called “DC”) provided by cloud service providers, instead of owning resources by themselves such as a server and a storage, are increasing. In addition, a case where DC is developed not only in Japan but also in overseas is increasing.

There may be a case where a control center (hereinafter, sometimes called “CC”) manages an operation status in each DC when a business operator uses resources of a plurality of DCs. For example, when any trouble occurs in one of the DCs, a person in charge of investigation in CC conducts an investigation thereof. When a cause of the trouble is found out, the person in charge of investigation registers information and so on for an update program such as a patch applied to respond to a failure in a database for failure information stored in CC in addition to information for the product in which the trouble occurs and the content of the failure. The person in charge of investigation also registers an applied update program in a database for update programs stored in CC. A person in charge of base in each DC refers to an update program registered in CC and applies the update program to the DC when it is determined that the update program should be applied.
Patent Literature 1: International Publication Pamphlet No. WO 2007/105274
Patent Literature 2: Japanese Laid-open Patent Publication No. 2008-198001
Patent Literature 3: Japanese Laid-open Patent Publication No. 2003-271387

However, in the technology, because determination of whether to apply the update program is left to the person in charge of base in each DC, an omission of application of the update program may occur in each DC. For example, because system quality may be degraded by applying the update program, the person in charge of base in each DC may decide not to apply the update program. Therefore, even if the CC integrally manages the update programs, some difference may occur in operation statues of the update programs in each DC.

### SUMMARY

According to an aspect of an embodiment, an application management device includes: a memory that stores therein application conditions for defining a condition of whether an update program is to be applied to a data center; and a processor that is connected to the memory, wherein the processor executes a process. The process includes acquiring information for an update program from a control center that manages failures in a plurality of data centers including the data center; and controlling the application of the update program to the data center based on the acquired information for the update program and the stored application conditions.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a system configuration diagram illustrating an example of an overall configuration of a global data center according to a first embodiment;

FIG. 2 is a functional block diagram illustrating an example of a functional configuration of a system according to the first embodiment;

FIG. 3 is a diagram illustrating an example of information stored in a failure information DB according to the first embodiment;

FIG. 4 is a diagram illustrating an example of information stored in a patch DB according to the first embodiment;

FIG. 5 is a diagram illustrating an example of information stored in a configuration DB in a base A according to the first embodiment;

FIG. 6 is a diagram illustrating an example of information stored in an application condition DB in the base A according to the first embodiment;

FIG. 7A is a diagram illustrating an example of creation date and time and access date and time of a target file in base A according to the first embodiment;

FIG. 7B is a diagram illustrating an example of creation date and time and access date and time of a target file in base B according to the first embodiment;

FIG. 8 is a diagram illustrating an example of information stored in a configuration DB in a base B according to the first embodiment;

FIG. 9 is a flowchart illustrating an example of patch application determining processing according to the first embodiment;

FIG. 10 is a flowchart illustrating an example of usage specifying processing according to the first embodiment;

FIG. 11 is a diagram illustrating an example of information stored in a related patch DB according to a second embodiment;

FIG. 12 is a flowchart illustrating an example of related patch determining processing according to the second embodiment; and

FIG. 13 is a diagram illustrating an example of a hardware configuration.

### DESCRIPTION OF EMBODIMENTS

Preferred embodiments of the present invention will be explained reference to accompanying drawings. It should be noted that the disclosed technology is not limited by the present embodiments. The following embodiments may be appropriately combined with each other within a range in which contradiction will not occur.

### [a] First Embodiment

### Description of CC and Bases

In the description herein below, an entire system including a plurality of data centers (hereinafter, sometimes called “DC”) is referred to as “Global data center” (hereinafter, sometimes called “GDC”), and each data center is referred to as “Base”. In the description herein below, a patch will be explained as an example of an update program.

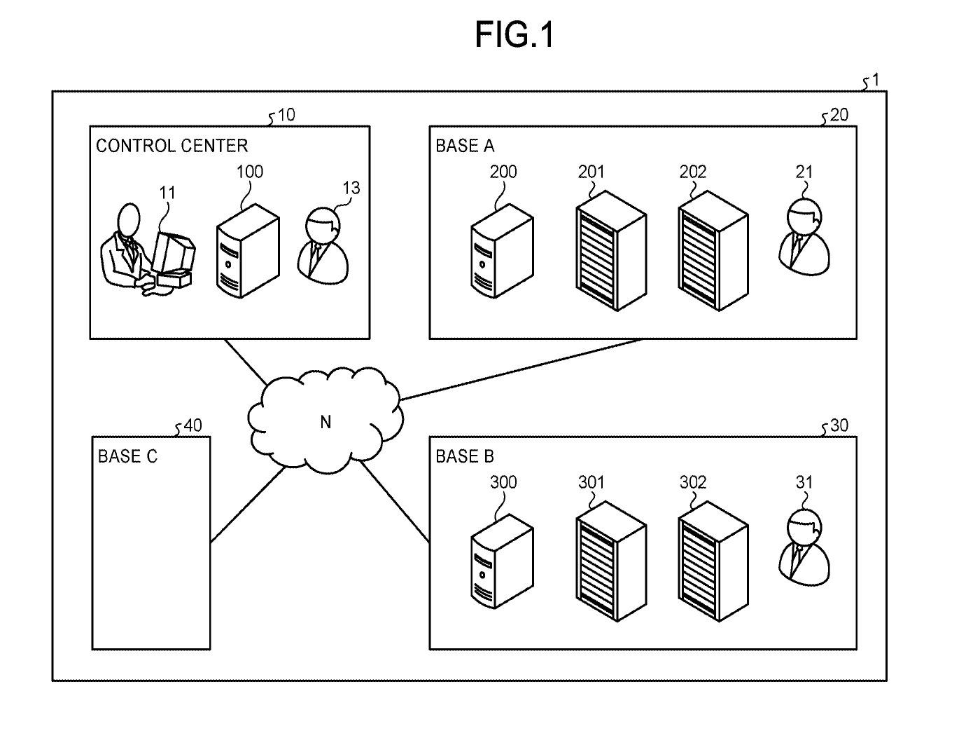

The present embodiment is implemented in GDC as illustrated in FIG. 1. FIG. 1 is a system configuration diagram illustrating an example of an overall configuration of a global data center according to a first embodiment. In GDC 1 according to the present embodiment, a single CC (control center) 10, a plurality of bases: base A 20, base B 30, and base C 40 are communicably connected to each other via a network N. Arbitrary types of communication networks such as the Internet, a local area network (LAN), or a Virtual Private Network (VPN) can be adopted in the network N regardless of wired or wireless. The number of bases is not limited to the illustrated one, and may therefore be a configuration including an arbitrary number of bases.

As illustrated in FIG. 1, the CC 10 includes a CC server 100, and an administrator 11 operates the CC server 100. Each base is a data center that holds, for example, a plurality of customer's computers, and includes a base management server, a computer of a customer A, and a computer of the other customer. The base management server is installed, for example, one by one in each base, and is operated by a person in charge of base in each base. Each base may be configured to include, for example, a plurality of other customer's computers, or may be configured not to include other customer's computers. Because the base B 30 and the base C 40 have the same configuration as that of the base A 20, the base A 20 will be explained below.

The CC server 100 manages information for failures that occur in each base and information for applied patches based on the operation by the administrator 11 or based on the information received from the other computer. The CC server 100 transmits the information for the failures and the information for the registered patches to the bases without delay, or transmits the information based on a request from each base. The CC 10 can be deployed in any location such as inside of the base A 20, and may be configured so that the administrator 11 remotely operates the CC server 100.

When any failure occurs in, for example, a computer 301 of the customer A installed in the base B 30, a person in charge of investigation 13 in the CC 10 investigates the cause of the failure, and also responds to the failure such as by creating a patch used for recovery or prevention of the failure or by acquiring a patch from the outside. The person in charge of investigation 13 registers the created or acquired patch in the CC server 100 or requests the administrator 11 to register the patch in the CC server 100. For example, the administrator 11 of the CC 10 or a person in charge of base 31 in the base B 30 may concurrently serve as the person in charge of investigation 13.

The base A 20 includes a base management server 200, a computer 201 of the customer A, and a computer 202 of the other customer. The base B 30 includes a base management server 300, a computer 301 of the customer A, and a computer 302 of the other customer. The computer 201 of the customer A is an example of the data center, the base management server 200 is an example of the application management device, and the customer A is an example of a user.

The base management server 200 is a server for managing a system configuration of the computer 201 of the customer A and application conditions for determining whether a patch is applied to the computer 201 of the customer A, and is operated by a person in charge of base 21. The base management server 200 may be installed in any location other than the base A 20 if the application of a patch can be controlled. The response to a case in which, for example, any failure occurs in the computer 201 of the customer A installed in the base A 20 is performed by the person in charge of investigation 13 in the CC 10 similarly to the case of the base B 30.

In the system, the base management server of each base controls the application of an update program to the data center based on the application conditions for defining a condition of whether the update program is to be applied to the data center and based on the information for the update program acquired from the control center for managing failures of the data centers including the data center. Thereby the application of update programs is controlled between the bases in a uniform condition, and it is thereby possible to suppress an omission of the application of any update program to the data center.

Configuration of Entire System

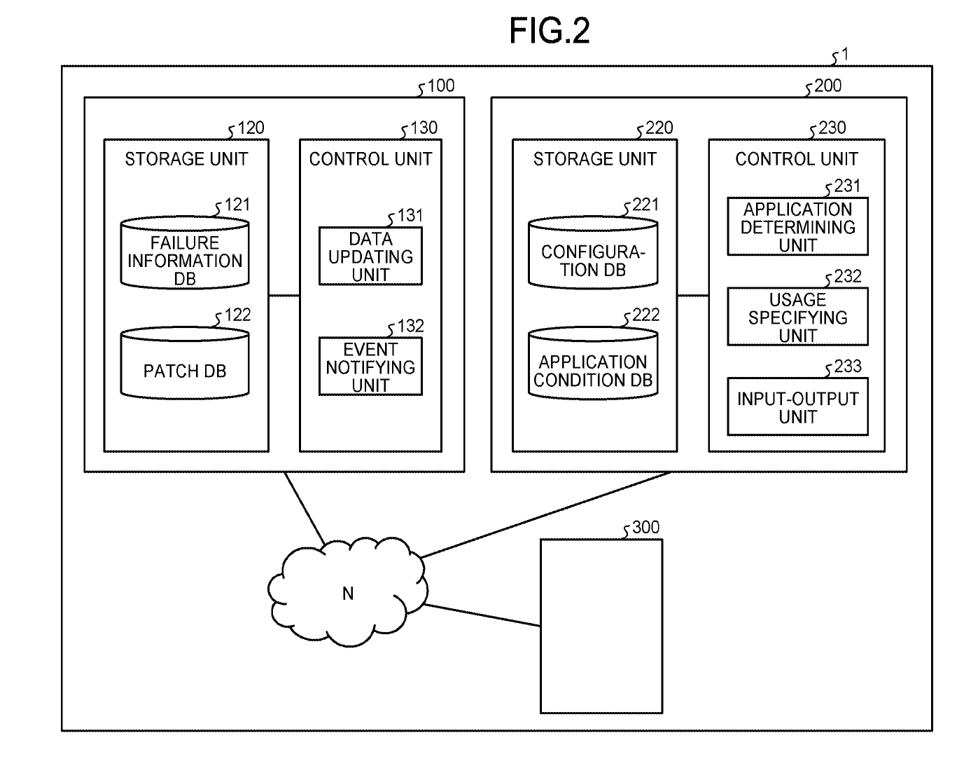

A functional configuration of the system implemented to manage patch application in GDC will be explained next. FIG. 2 is a functional block diagram illustrating an example of the functional configuration of the system according to the first embodiment. As illustrated in FIG. 2, the system according to the present embodiment is included in the GDC 1, and includes the CC server 100, the base management server 200, and a base management server 300.

Functional Configuration of CC Server

The functional configuration of the CC server 100 will be explained first. As illustrated in FIG. 2, the CC server 100 includes a storage unit 120 and a control unit 130. The CC server 100 may be configured to include various types of function units provided in a known computer other than the function units illustrated in FIG. 2, for example, various types of input device and sound output device.

The storage unit 120 is implemented by, for example, a storage device such as a semiconductor memory device such as random access memory (RAM) and a flash memory, a hard disk, and an optical disk. The storage unit 120 includes a failure information database (DB) 121 and a patch DB 122. The storage unit 120 stores various types of information used for processing in the control unit 130.

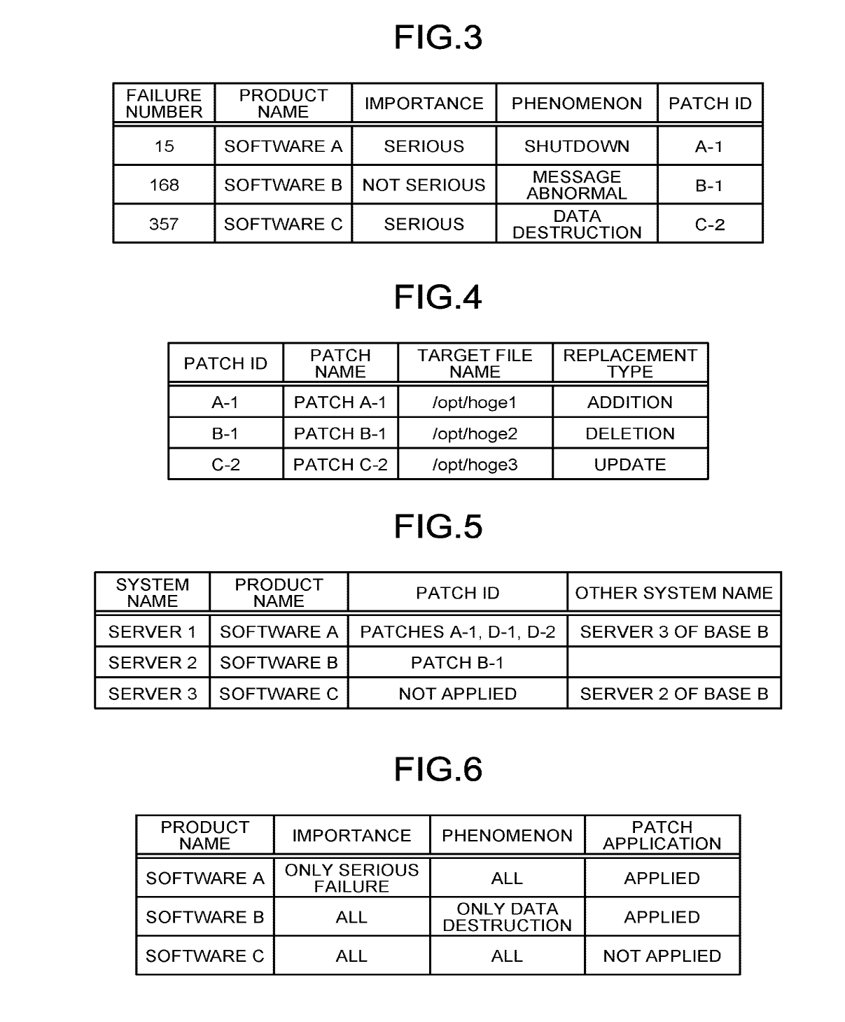

The failure information DB 121 stores information for failures that occur in the bases. FIG. 3 is a diagram illustrating an example of information stored in the failure information DB according to the first embodiment. As illustrated in FIG. 3, the failure information DB 121 stores “Product Name”, “Importance”, “Phenomenon”, and “Patch ID” in association with “Failure Number”.

In the example of FIG. 3, “Failure Number” is a number for uniquely identifying a failure that occurs. “Product Name” represents a software name as a target of the failure. “Patch ID” represents information for uniquely identifying a patch to be applied for recovery or prevention of the target of the failure. “Importance” indicates how important the failure is. “Phenomenon” indicates what kind of phenomenon is brought by the failure. For example, the failure of a failure number “15” is a “serious” failure of which target is “Software A”, which leads to “Shutdown” of the system. “Patch ID” of the patch applied to the failure is “A-1”.

The patch DB 122 stores information and the like for failures corresponding to respective patches. FIG. 4 is a diagram illustrating an example of information stored in the patch DB according to the first embodiment. As illustrated in FIG. 4, the patch DB 122 stores “Patch name”, “Target File Name”, and “Replacement Type” in association with “Patch ID”.

In the example of FIG. 4, “Patch name” represents a name of a patch corresponding to the Patch ID. “Target File Name” represents a file name to which the patch is applied and a path name. “Replacement Type” indicates whether the patch newly adds a target file, or deletes an existing target file or updates the content of the existing target file. For example, the name of the patch indicated by Patch ID “A-1” is “Patch A-1”, and a target file “/opt/hoge1” is newly added.

The control unit 130 is implemented by, for example, a central processing unit (CPU) or a micro processing unit (MPU) that executes the program stored in the internal storage device using RAM as a work area. The control unit 130 may also be implemented by an integrated circuit such as an application specific integrated circuit (ASIC) or a field programmable gate array (FPGA).

The control unit 130 includes a data updating unit 131 and an event notifying unit 132, and implements or executes a function or an action of information processing which will be explained below. The internal configuration of the control unit 130 is not limited to the configuration illustrated in FIG. 2, and may be any other configuration if it is a configuration of performing information processing explained later. For example, each of the processing units performs data transmission/reception with other computer such as the base management server 200 via a communication unit (not illustrated). For example, each of the processing units may be configured to update the content of the failure information DB 121 in response to reception of the operation by the administrator 11 via an input unit (not illustrated), or to cause an output unit (not illustrated) to output an instruction for patch application. The data updating unit 131 and the event notifying unit 132 are an example of an electronic circuit such as a processor or an example of a process executed by the processor or the like.

The data updating unit 131 is a processor that updates each DB based on, for example, the information received from the base management server 200 or the instruction input from the administrator 11. Specifically, the data updating unit 131 receives a product name, importance, a phenomenon that occurs, and a patch ID which are targets of the failure, as information for the failure from the base management server 200, or from a terminal of the person in charge of base 21, or from a terminal of the person in charge of investigation 13, and stores the received information in the failure information DB 121. The data updating unit 131 registers, as information for a patch, for example, a patch name, a target file name, and a replacement type in the patch DB 122. The data updating unit 131 may be configured so as to update each DB based on the information for the failure input by the administrator 11.

The event notifying unit 132 is a processor that transmits failure information and information for a patch to each base based on the information registered in the failure information DB 121. Specifically, the event notifying unit 132 refers to the failure information DB 121 periodically or at an arbitrary timing or at a timing at which the failure information DB 121 is updated, and transmits the information for the registered failure to each base. When receiving an acquisition request of the failure information from the base management server 200, the event notifying unit 132 refers to the failure information DB 121 and transmits the failure information to the base management server 200.

Functional Configuration of Base Management Server

The functional configuration of the base management server 200 will be explained next. As illustrated in FIG. 2, the base management server 200 includes a storage unit 220 and a control unit 230. The base management server 200 may be configured to include various function units provided in an existing computer other than the function units illustrated in FIG. 2, for example, function units such as various types of input device and sound output device.

The storage unit 220 is implemented by a storage device such as a semiconductor memory device including RAM and a flash memory, a hard disk, and an optical disk. The storage unit 220 includes a configuration DB 221 and an application condition DB 222. The storage unit 220 stores various types of information used for processing in the control unit 230.

The configuration DB 221 stores a system configuration in each base. FIG. 5 is a diagram illustrating an example of information stored in the configuration DB in the base A according to the first embodiment. As illustrated in FIG. 5, the configuration DB 221 stores “Product Name”, “Patch ID”, and “Other System Name” in association with “System Name”.

“System Name” represents a name of a target computer. “Product Name” represents a software name installed on the computer. “Patch ID” represents a patch ID of a patch applied to the system. “Other System Name” represents a name of a system, installed in the other base, having a configuration the same as or similar to that of the system. The content of the configuration DB 221 is updated, for example, when a new system is introduced in each base, or when new software is installed on or a new patch is applied to an introduced system.

In the example of FIG. 5, for example, “Software A” is installed on the computer whose system name is “Server 1”, and “Patch A-1”, “Patch D-1”, and “Patch D-2” are applied thereto. It is also stored that the system having the configuration the same as or similar to that of the server 1 is also provided in “Server 3” of the base B.

The application condition DB 222 stores conditions for determining whether to apply a patch in the base. FIG. 6 is a diagram illustrating an example of information stored in the application condition DB in the base A according to the first embodiment. As illustrated in FIG. 6, the application condition DB 222 stores “Importance”, “Phenomenon”, and “Patch Application” in association with “Product Name”.

In the example of FIG. 6, “Importance” indicates whether it is determined that the patch meets the condition only in a serious case or it is determined that the patch meets the condition regardless of the importance. “Phenomenon” indicates what kind of phenomenon meets the condition. “Patch Application” indicates that it is determined whether “Patch is applied” or “Patch is not applied” when the patch meets the condition.

For the software A, for example, it is stored that the patch is applied only when a serious failure may possibly occur, regardless of what kind of phenomenon occurs. On the other hand, for software C, it is stored that the patch is not applied regardless of whether the importance is significant or regardless of what kind of phenomenon occurs. “Importance” and “Phenomenon” represented as the application conditions are only examples, and therefore it may be configured to include other application conditions. In the present embodiment, although an example of determining whether patch application is needed when both “Importance” and “Phenomenon” satisfy the condition will be explained, it may be configured to determine whether the patch application is needed when either one of them satisfies the condition.

The control unit 230 is implemented by, for example, CPU or MPU that executes the program stored in the internal storage device using the RAM as a work area. The control unit 230 may be implemented by an integrated circuit such as ASIC or FPGA.

The control unit 230 includes an application determining unit 231, a usage specifying unit 232, and an input-output unit 233, and implements or executes a function or an action of information processing which will be explained below. The application determining unit 231 and the usage specifying unit 232 are an example of an application control unit. The input-output unit 233 is an example of an acquiring unit and the application control unit.

The internal configuration of the control unit 230 is not limited to the configuration illustrated in FIG. 2, and therefore it may be some other configuration if the configuration performs information processing explained later. For example, each of the processing units performs data transmission/reception with other computer such as the CC server 100 via a communication unit (not illustrated). The application determining unit 231, the usage specifying unit 232, and the input-output unit 233 are an example of an electronic circuit such as a processor or an example of a process performed by a processor or so.

The application determining unit 231 is a processor that determines whether a patch is applied. Specifically, the application determining unit 231 refers to the failure information DB 121 of the CC server 100 periodically or at an arbitrary timing, or receives a notification from the event notifying unit 132 of the CC server 100, and acquires newly registered or updated failure information. When acquiring the newly registered or updated failure information, the application determining unit 231 refers to the application condition DB 222, and determines whether a patch specified by the failure information meets the condition for applying the patch to the computer 201 of the customer A installed in the base A. When it is determined that the patch specified by the failure information meets the condition, the application determining unit 231 causes the input-output unit 233 to output an instruction to apply the patch.

For example, when acquiring the failure information of the failure number “15” illustrated in FIG. 3, the application determining unit 231 refers to the application condition DB 222 illustrated in FIG. 6 and acquires the application condition for “Software A” that is targeted by the failure information. The application determining unit 231 checks the application condition DB 222 against the failure information, and determines that the patch is “applied” because the failure information indicates “serious”.

On the other hand, when acquiring the failure information of a failure number “357”, the application determining unit 231 refers to the application condition DB 222 for “Software C” as a target. As a result, because it is defined that the patch is “not applied” in the application condition DB 222 although the failure information is “serious” and this failure leads to “Data Destruction”, the application determining unit 231 determines that the patch is “not applied”. In this case, the application determining unit 231 ends the processing for the failure information without determining the application of the patch.

Moreover, when acquiring the failure information of a failure number “168”, the application determining unit 231 refers to the application condition DB 222 for “Software B” as a target. Because it is defined that the phenomenon included in the failure information is “Message Abnormal” and this does not lead to “Data Destruction”, the application determining unit 231 does not determine that the patch is “applied”. On the other hand, for “Software B”, unlike “Software C”, it is not defined that the patch is “not applied” in the application condition DB 222. In this case, the application determining unit 231 instructs the usage specifying unit 232 to specify the usage of a target file of Patch ID “B-1” even without determining that the patch is “not applied”.

Referring back to the explanation of FIG. 2, the usage specifying unit 232 is a processor that specifies a usage of a target file as a target of patch application and controls the patch application based on the usage of the specified target file. Specifically, when receiving an input of a checking request of the usage of the target file in the computer inside a local base from the application determining unit 231, the usage specifying unit 232 specifies whether the target file is used, and outputs the result of the specification. Whether the target file is used is specified by acquiring file creation date and time and file access date and time of the target file from, for example, a file system of each computer (not illustrated), and comparing these two.

For example, when the file access date and time is earlier than the file creation date and time, the usage specifying unit 232 specifies that the target file is used. The usage specifying unit 232 specifies that the target file is not used when the file access date and time is not recorded, when the file creation date and time and the file access date and time coincide with each other, or when the file creation date and time is earlier than the file access date and time. When it is specified that the target file of the patch is used, the usage specifying unit 232 causes the input-output unit 233 to output an instruction to apply the patch.

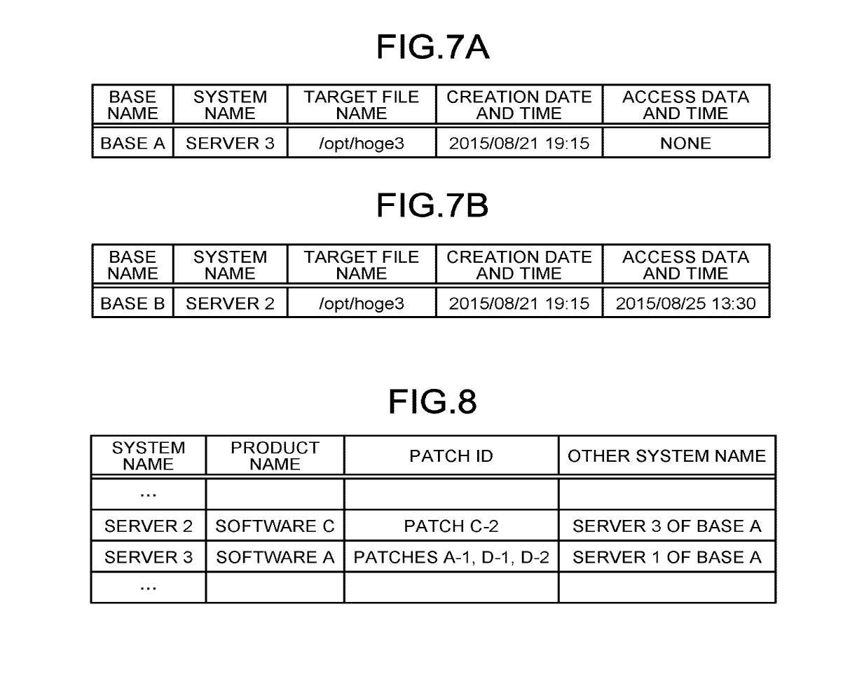

A configuration for specifying whether the target file is used will be explained with reference to FIG. 7A and FIG. 7B. FIG. 7A is a diagram illustrating an example of creation date and time and access date and time of the target file in base A according to the first embodiment. And FIG. 7B is a diagram illustrating an example of creation date and time and access date and time of the target file in base B according to the first embodiment. For example, the usage specifying unit 232 acquires information such as “st_btime” indicating file creation date and time of a target file and information such as “st_atime” indicating access date and time to a file from the file system, and compares these two.

For the server 3 of the base A, FIG. 7A represents an example in which information indicating the file creation date and time of a target file “/opt/hoge3” is recorded but information indicating access date and time to the file is not recoded. Because the access date and time is not recorded, the usage specifying unit 232 specifies that the target file is not used in the server 3 of the base A.

On the other hand, FIG. 7B represents an example in which the date and time after the information indicating the file creation date and time is recorded in the information indicating the access date and time to the target file. In this case, because the access date and time to the target file is later than the creation date and time of the target file, it is specified that the target file is used in the server 2 of the base B.

For example, when it is specified that the target file is not used in the computer 201 of the customer A, the usage specifying unit 232 refers to the configuration DB 221, and specifies whether there is any computer having the configuration the same as or similar to that of the computer 201 of the customer A in the other base.

For example, in a computer that does not operate by itself such as a standby system server but preferably synchronizes a system configuration with an active system server, it is preferable to determine that the patch is applied even when the target file of the patch is not executed. Therefore, the usage specifying unit 232 specifies, in the local base, the usage of the target file in the computer, in the other base, having the configuration the same as or similar to that of a computer on which a target product of the patch is installed.

For the configuration for specifying the usage of a target file in the other base, a case where a patch is not yet applied and a target file of the patch is not used will be explained as an example. First of all, the application determining unit 231 refers to the configuration DB 221 illustrated in FIG. 5, and specifies that the patch for “Software C” is not yet applied in the server 3 of the base A. The usage specifying unit 232 refers to, as explained above, the usage of the target file in the server 3 of the base A as illustrated in FIG. 7A, and specifies that the target file is not used.

In this case, the usage specifying unit 232 refers to the configuration DB 221, and specifies that “Server 2 of Base B” is the system the same as or similar to the server 3 of the base A. The usage specifying unit 232 transmits a checking request of the usage of the target file in the server 2 of the base B to the base management server 300 in the other base 3.

The system configuration in the other base B will be explained below with reference to FIG. 8. FIG. 8 is a diagram illustrating an example of information stored in the configuration DB in the base B according to the first embodiment. Items of the configuration DB illustrated in FIG. 8 represent targets the same as these of the items of the configuration DB illustrated in FIG. 5. As illustrated in FIG. 8, “Software C” is installed on “Server 2 of Base B” similarly to the “Server 3 of Base A”. On the other hand, the server 2 of the base B is different from the server 3 of the base A in that “Patch C-2” is already applied thereto.

The base management server 300 of the base B that receives the checking request of the usage of the target file specifies the usage of the target file in the server 2 of the base B. The base management server 300 of the base B specifies that the target file is used in the server 2 of the base B as explained above as a result of referring to the information illustrated in FIG. 7B, and transmits the result of the specification to the base management server 200 of the base A.

When receiving the information for specifying that the target file of the patch is used in the server 2 of the base B, the usage specifying unit 232 of the base management server 200 of the base A also causes the input-output unit 233 to output an instruction to apply the patch. In other words, even when the target file of the patch is used in the computer, in the other base, having the configuration the same as or similar to that of the computer in the local base, the usage specifying unit 232 also performs determination similarly to that of the case in which the target file of the patch is used in the computer of the local base. In other words, when the target file of the patch is used in the computer, in the other base, having the configuration the same as or similar to that of the computer in the local base, the usage specifying unit 232 determines that the patch is applied.

For a patch of which replacement type is “Addition” in the patch DB 122, when there is a target file in the other base, it is considered that the patch is already applied in the other base, regardless of whether the target file is used. In this case, the usage specifying unit 232 may be configured so as to determine that the patch is applied, regardless of whether the target file is used in the other base.

Furthermore, the usage specifying unit 232 specifies whether the target file is used when receiving the checking request of the usage of the target file from the base management server 300 of the other base, and returns the result of specification.

FIG. 2 represents the case in which the other base is one, however, when a plurality of other cases are provided, the usage specifying unit 232 sequentially transmits the checking request of the usage of the target file to each of the bases. However, when a result of specification that the target file is used is acquired from any one of the bases, it may be configured so as not to redundantly transmit the checking request of the usage of the target file to the other bases.

FIG. 7A, FIG. 7B and FIG. 8 represent the configuration that specifies whether the target file of the patch is used in the computer in the other base the same as or similar to the computer, however, the embodiments are not limited thereto. For example, when it is specified whether the patch as a target to be determined is applied in the computer of the other base and it is determined that the patch is applied, it may be configured so as to determine that the patch as the target to be determined is applied also in the local base.

Referring back to the explanation of FIG. 2, the input-output unit 233 is a processor that performs input and output based on the results of processing of the application determining unit 231 and the usage specifying unit 232. Specifically, the input-output unit 233 outputs an application instruction of a patch based on the result of determination of whether patch application is needed by the application determining unit 231 or by the usage specifying unit 232. The input-output unit 233 outputs an application instruction of a patch to, for example, patch application software (not illustrated), however, the embodiments are not limited thereto. Therefore, it may be configured so as to display a message instructing patch application on a terminal of the person in charge or to transmit an email to a terminal of the person in charge.

The input-output unit 233 receives an instruction to update the configuration DB 221 or the application condition DB 222 from, for example, the person in charge of base 21, and updates the configuration DB 221 or the application condition DB 222.

Flow of Processing

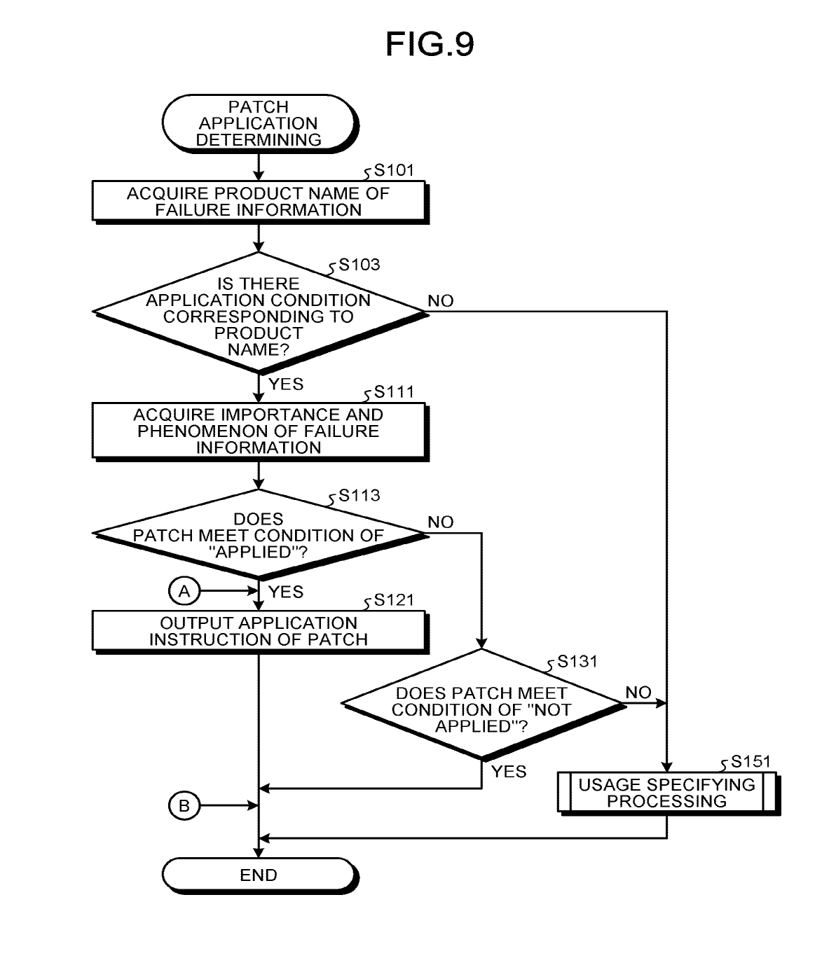

The flow of processing performed by the base management server 200 will be explained next. FIG. 9 is a flowchart illustrating an example of patch application determining processing according to the first embodiment. First of all, the application determining unit 231 of the base management server 200 acquires a product name from, for example, the failure information acquired from the CC server 100 (Step S101). Subsequently, the application determining unit 231 determines whether the application condition corresponding to the product name is registered in the application condition DB 222 (Step S103). When the application condition corresponding to the product name is not registered (No at Step S103), the application determining unit 231 proceeds to Step S151, and performs usage specifying processing which will be explained later.

When the application condition corresponding to the product name is registered (Yes at Step S103), the application determining unit 231 acquires the importance and the phenomenon included in the failure information (Step S111). Subsequently, the application determining unit 231 determines whether the importance and the phenomenon satisfy an application condition “Patch is applied” corresponding to the product name registered in the application condition DB 222 (Step S113). When both of them satisfy the application condition “Patch is applied” (Yes at Step S113), the input-output unit 233 outputs an instruction to apply the patch specified in the failure information (Step S121).

Meanwhile, when both of them do not satisfy the application condition “Patch is applied” (No at Step S113), the application determining unit 231 refers to the application condition DB 222 and determines whether the importance and the phenomenon included in the failure information satisfy an application condition “Patch is not applied” (Step S131). When both of them satisfy the application condition “Patch is not applied” (Yes at Step S131), the application determining unit 231 ends the processing without outputting the application instruction of the patch. Meanwhile, when both of them do not satisfy the application condition “Patch is not applied” (No at Step S131), the application determining unit 231 proceeds to Step S151, and performs the usage specifying processing which will be explained later.

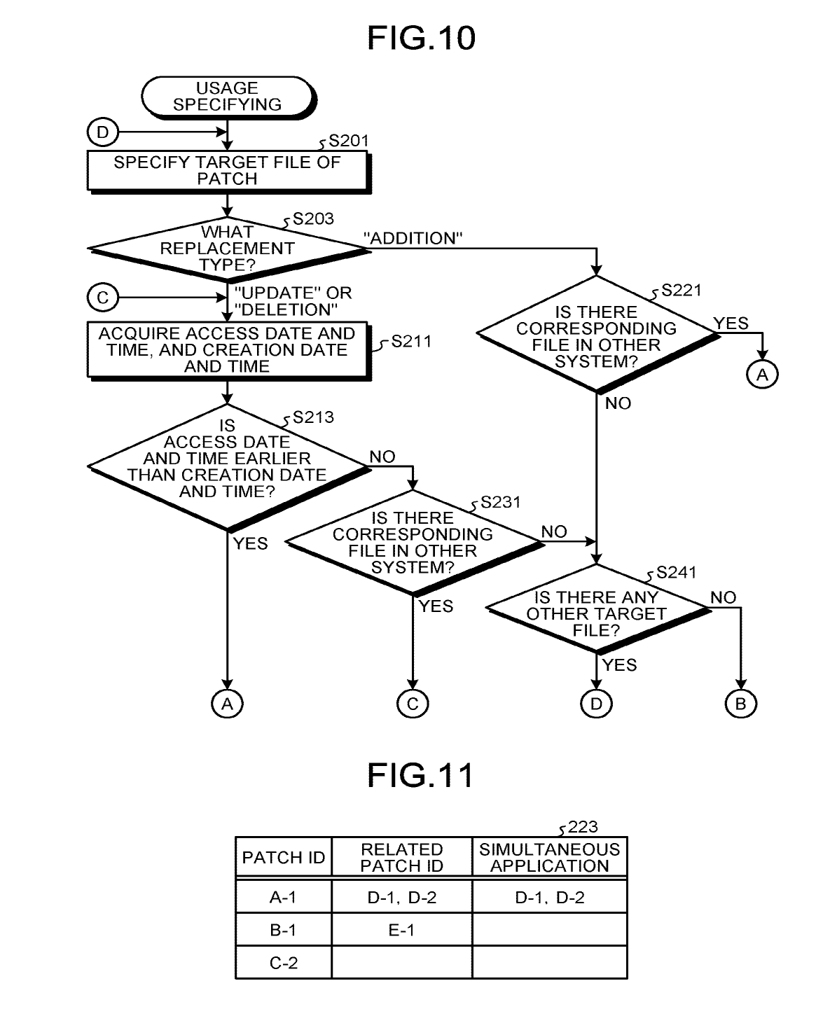

The usage specifying processing in the base management server 200 will be explained next with reference to FIG. 10. FIG. 10 is a flowchart illustrating an example of usage specifying processing according to the first embodiment. First of all, the usage specifying unit 232 of the base management server 200 specifies a file name, which is registered in the patch DB 122 of the CC server 100, as a target to be updated by the patch corresponding to the failure information (Step S201). Subsequently, the usage specifying unit 232 determines whether the replacement type of the file by the patch is “Addition”, or “Update” or “Deletion” (Step S203).

When the replacement type is “Addition” (“Addition” at Step S203), the usage specifying unit 232 determines whether the file exists in the other base (Step S221). When the file exists in the other base (Yes at Step S221), the application determining unit 231 proceeds to Step S121 of the patch application determining processing through a connector A, and outputs an instruction to apply the patch specified in the failure information. When the file does not exist in the other base (No at Step S221), the application determining unit 231 proceeds to Step S241.

Meanwhile, when the replacement type is “Update” or “Deletion” (“Update” or “Deletion” at Step S203), the usage specifying unit 232 acquires the access date and time of the file and the creation date and time of the file in the corresponding system (Step S211). Subsequently, the usage specifying unit 232 compares which of the access date and time of the file and the creation date and time of the file is newer (Step S213).

When the access date and time is newer than the creation date and time (Yes at Step S213), the input-output unit 233 proceeds to Step S121 of the patch application determining processing through the connector A, and outputs the instruction to apply the patch specified in the failure information. Meanwhile, when the access date and time is not recorded, when the creation date and time coincides with the access date and time, or when the creation date and time is newer than the access date and time (No at Step S213), the usage specifying unit 232 executes Step S231. In other words, the usage specifying unit 232 refers to the configuration DB 221 and determines whether the file exists in the other base (Step S231).

When the file exists in the other base (Yes at Step S231), the usage specifying unit 232 proceeds to Step S211 through a connector C, and acquires the access date and time and the creation date and time of the file in the other base. Subsequently, when it is specified that the file is used at Step S213 (Yes at Step S213), the input-output unit 233 proceeds to Step S121 through the connector A, and outputs the instruction to apply the patch specified in the failure information. When it is specified that the file is not used (No at Step S213), the usage specifying unit 232 refers to the configuration DB 221 and determines whether there is any system in a further other base where the file exists (Step S231).

Meanwhile, when the file does not exist in the other base (No at Step S231), the usage specifying unit 232 determines whether any other file as a target to be updated by the patch corresponding to the failure information exists (Step S241). The same goes for the case in which it is determined that the file does not exist in the other base at Step S221 (No at Step S221). When any other file as a target to be updated exists (Yes at Step S241), the usage specifying unit 232 proceeds to Step S201 through a connector D, and repeats the processing for the other file. Meanwhile, when there is no file as a target to be updated (No at Step S241), the usage specifying unit 232 proceeds to the patch application determining processing trough a connector B, and ends the processing without outputting the application instruction of the patch.

According to the present embodiment, the base management server of each base controls the application of an update program to a data center based on the application conditions for defining a condition of whether the update program is applied to the data center and the information for the update program acquired from the control center that manages failures of a plurality of data centers including the data center. Thus, the bases can integrally manage patch application to computers without depending on the determination of each person in charge of the bases, and it is thereby possible to suppress an omission of patch application.

When a file as a target of patch application is not used in a target computer, the usage specifying unit 232 checks the usage of the file in the computer installed in the other base. Thus, it is possible to suppress an omission of patch application by determining whether patch application is needed even for a computer that does not use a file in, for example, a standby system similarly to the other computer such as an active system.

It may also be configured so that the CC server 100, instead of the base management server 200 or 300 in each base, integrally manages usages of files in computers installed in the bases. In this case, the usage specifying unit 232 of the base A 20 acquires the usage of the file in the computer installed in the other base from, for example, the CC server 100 instead of the base management server 300 in the other base.

### [b] Second Embodiment

Incidentally, the patch also includes patches (hereinafter, sometimes called “related patch(es)”) that do not appropriately operate unless they are applied to a plurality of products, such as update of an interface between products. The related patches include, for example, a patch that replaces the same file as a file as a replacement target of a specific patch (hereinafter, sometimes called “target file”) and a patch that replaces a file that cooperates with the target file (hereinafter, sometimes called “cooperative file”). The related patches include patches that do not appropriately operate unless they are applied at the same time or in a predetermined order.

The related patches are preferably applied collectively in each base regardless of the application conditions or the like of the patch application. Therefore, a second embodiment will explain the configuration that suppresses an omission of application of related patches by integrally managing related patches.

The present embodiment is implemented in GDC illustrated in FIG. 1 similarly to the first embodiment. In the system according to the present embodiment, the storage unit 220 of the base management server 200 further include a related patch DB 223 in addition to the functional configuration of the system as illustrated in FIG. 2. FIG. 11 is a diagram illustrating an example of information stored in the related patch DB according to the second embodiment. As illustrated in FIG. 11, the related patch DB 223 according to the present embodiment stores “Related Patch ID” and “Simultaneous Application” in association with “Patch ID”.

“Related Patch ID” indicates identification information of a patch, when a patch indicated by “Patch ID” is applied, which is preferably applied in combination with the patch. “Simultaneous Application” indicates identification information of a patch which is preferably applied simultaneously with the patch indicated by “Patch ID” among the related patches.

The example illustrated in FIG. 11 indicates that, when a patch indicated by “A-1” is to be applied, it is preferable that a patch indicated by “D-1” and a patch indicated by “D-2” are simultaneously applied. On the other hand, the example illustrated in FIG. 11 indicates that, when a patch indicated by “B-1” is to be applied, it is preferable to apply a patch indicated by “E-1” but it is not necessarily simultaneously applied. The example illustrated in FIG. 11 indicates that, when a patch indicated by “C-2” is to be applied, the patch does not have to be applied in particular in combination with any other patch.

In the present embodiment, the application determining unit 231 specifies whether the related patch corresponding to the patch as a target to be determined is registered in the related patch DB 223. When the related patch is not registered therein, the application determining unit 231 performs the patch application determining processing on the patch as the target to be determined.

When the related patch is registered, the application determining unit 231 refers to the configuration DB 221 to specify whether the related patch is already applied to the computer 201 of the customer A. When it is specified that the related patch is not applied to the computer 201 of the customer A, the application determining unit 231 performs the patch application determining processing on the patch as the target to be determined.

When it is specified that the related patch is applied to the computer 201 of the customer A, the application determining unit 231 determines that the patch as the target to be determined is “applied” without performing the patch application determining processing illustrated in FIG. 9.

For example, the application determining unit 231 specifies that the patch indicated by “E-1” is registered as the related patch as a result of referring to the related patch DB 223 when it is determined whether the patch indicated by “B-1” needs to be applied. In this case, the application determining unit 231 refers to the configuration DB 221 to specify whether the related patch indicated by “E-1” is applied to the computer 201 of the customer A. When it is specified that the related patch indicated by “E-1” is applied, the application determining unit 231 determines that the patch indicated by “B-1” is “applied” regardless of the application conditions or the like stored in the application condition DB 222.

In the present embodiment, when it is determined that the specific patch is “applied”, the application determining unit 231 determines that the related patch, which is registered in the related patch DB 223 corresponding to the patch but is not yet applied, is also “applied”. For example, when it is determined that the patch indicated by “A-1” is “applied”, the application determining unit 231 refers to the related patch DB 223 to specify the related patches “D-1” and “D-2” corresponding to the patch. The application determining unit 231 determines that the patch indicated by “D-1” and the patch indicated by “D-2” are “applied” regardless of the application conditions or the like stored in the application condition DB 222.

As explained above, when it is determined that the patch or the related patch as the target to be determined is “applied”, the input-output unit 233 outputs an application instruction of each patch. When it is determined that the patch as the target to be determined and the related patch whose information for the simultaneous application is not registered are “applied”, the input-output unit 233 may be configured not to output an application instruction of the related patch at the same time when an application instruction of the patch as the target to be determined is output.

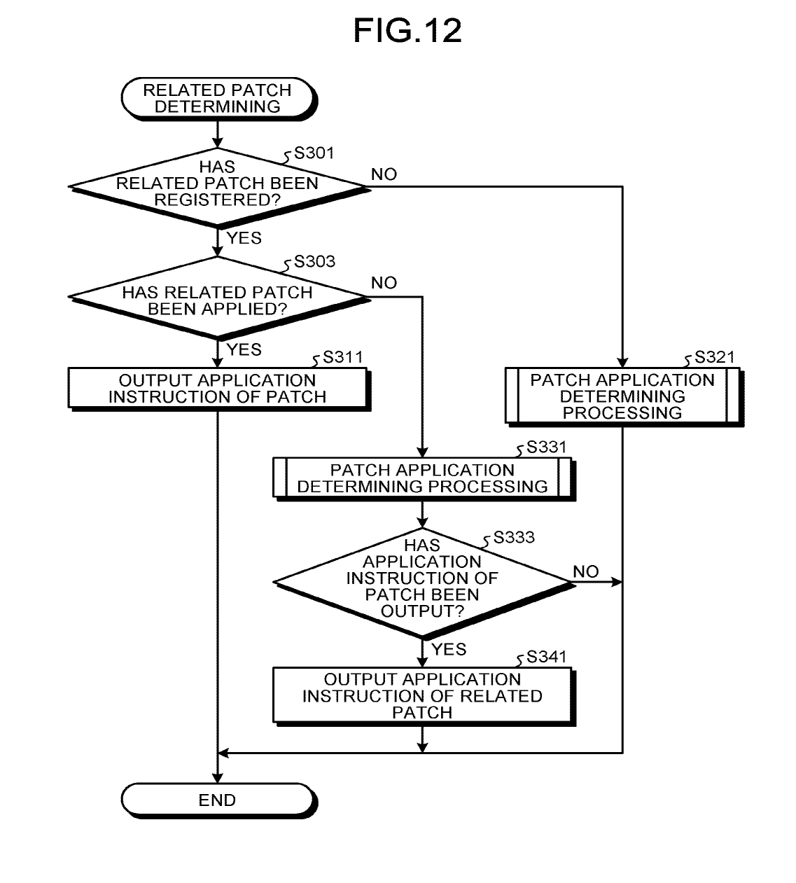

The flow of processing performed by the base management server 200 according to the present embodiment will be explained below with reference to FIG. 12. FIG. 12 is a flowchart illustrating an example of related patch determining processing according to the second embodiment. First of all, the application determining unit 231 of the base management server 200 specifies whether a related patch to the patch specified in the failure information has been registered in the related patch DB 223 (Step S301). When the related patch has not been registered (No at Step S301), the application determining unit 231 performs the patch application determining processing also on the patch similarly to the other patches (Step S321), and ends the processing.

When the related patch has been registered (Yes at Step S301), the application determining unit 231 specifies whether the related patch registered in the related patch DB 223 has been applied to the computer 201 of the customer A (Step S303). When the related patch has been applied to the computer 201 of the customer A (Yes at Step S303), the application determining unit 231 outputs the patch application of the patch (Step S311).

Meanwhile, when the related patch has not been applied to the computer 201 of the customer A (No at Step S303), the application determining unit 231 performs the patch application determining processing also on the patch similarly to the other patches (Step S331). When the patch application of the patch has not been output as a result of the patch application determining processing (No at Step S333), the application determining unit 231 ends the processing. When the patch application of the patch has been output (Yes at Step S333), the application determining unit 231 outputs an application instruction of also the related patch of the patch (Step S341).

According to the present embodiment, for patches related to a plurality of products, patch application to each computer can be integrally managed without depending on the determination of each person in charge, and it is thereby possible to suppress an omission of application of related patches.

For patches that do not appropriately operate unless they are simultaneously applied, the patches are simultaneously applied based on the content registered in the related patch DB 223, and it is thereby possible to prevent a defect at the time of patch application.

Although the present embodiment has explained the configuration in which each of the base management servers of the bases has the related patch DB, the embodiments are not limited thereto. Therefore, it may be configured that the CC server 100 includes the related patch DB. In addition, although the present embodiment has explained the configuration in which information for patches which are preferably applied simultaneously is registered, the embodiments are not limited thereto. Therefore, for patches which are preferably applied in a predetermined order, it may be configured that the order of application is registered in the related patch DB 223.

### [c] Third Embodiment

Although the embodiments of the present invention have been explained so far, the present invention may be implemented in various different embodiments other than the embodiments. For example, the processings represented in FIG. 9, FIG. 10 and FIG. 12 are not limited to the order but may be implemented at the same time or may be implemented in a reverse order within a range which does not contradict the processing contents. For example, in the patch application determining processing illustrated in FIG. 9, it may be configured that it is first determined whether the patch meets the application condition “Patch is not applied” (Step S131), and then it is determined whether it meets the application condition “Patch is applied” (Step S113).

Of the processings explained in the present embodiments, all or part of the processings explained as these automatically performed may be performed manually. Alternatively, all or part of the processings explained as these manually performed may be performed automatically using a known method. In addition, the information including the procedures, the control procedures, the specific names, and the various kinds of data and parameters represented in the document and drawings can be arbitrarily changed, unless otherwise specified.

The embodiments have explained the configuration in which the application condition DB 222 is provided in the base A 20 and the application conditions are set according to the system configuration of each base, however, the embodiments are not limited thereto. For example, it may be configured that the CC server 100 integrates the application condition DBs provided in the bases and updates them, or it may be configured that the application condition DBs are provided in the CC server 100 and are integrally managed thereby. In the configuration, because the application conditions are centralized in all the bases, a difference between patch application statuses is further reduced.

The embodiments have explained the example of applying patches to servers that are decentrally installed in the data centers, however, the embodiments are not limited thereto. For example, it may be an embodiment such that a patch is applied to terminals installed in a plurality of departments. Thus, it is possible to suppress an omission of the patch application in the terminals of some bases similarly to the servers.

The respective components of the illustrated devices are functionally conceptual, and the components are not necessarily configured as physically illustrated ones. In other words, the specific mode of decentralization and integration of the devices is not limited to the illustrated ones. Namely, it may be configured by functionally or physically decentralizing or integrating all or part of the devices in an arbitrary unit according to the various kinds of load and usages. For example, it may be configured that the base management server 200 integrates the functions of the CC server 100, or it may be configured that the functions of the CC server 100 and the functions of the base management server 200 are decentrally implemented in the servers. Furthermore, all or arbitrary part of the processing functions performed in the respective devices can be implemented by a CPU and a program analyzed and executed by the CPU, or can be implemented as hardware by wired logic.

System

The embodiments related to the disclosed system have been explained so far, and an example of a hardware configuration of the base management server 200 in each of the embodiments will be explained below. The whole of or any part of the various processing functions performed by the devices may be performed on a CPU (or a microcomputer such as MPU and a micro controller unit (MCU)). It goes without saying that the whole of or any part of the various processing functions may be performed on the program analyzed and executed by the CPU (or a microcomputer such as MPU and MCU) or on the hardware by wired logic. The various types of processing explained in the embodiments can be implemented by a computer executing the program prepared in advance. Therefore, as an example of the hardware configuration, an example of a computer executing the program having the same functions as these of the embodiments will be explained below.

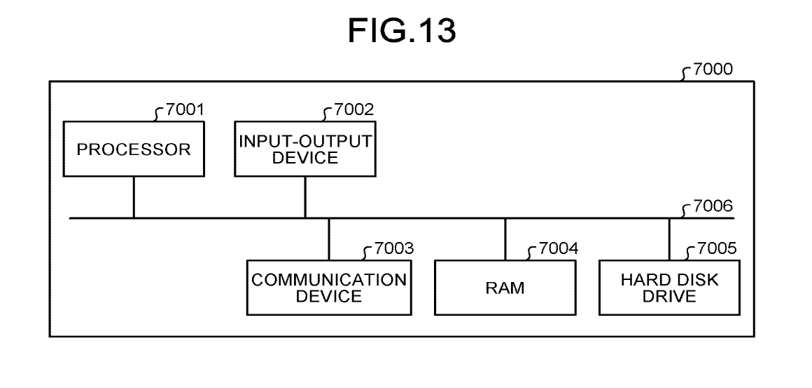

FIG. 13 is a diagram illustrating an example of the hardware configuration. The base management server 200 can be implemented by the hardware configuration the same as that of a computer 7000 illustrated in FIG. 13. As illustrated in FIG. 13, the computer 7000 includes a processor 7001 that executes various types of arithmetic processing, an input-output device 7002, and a communication device 7003. The computer 7000 also includes RAM 7004 that temporarily stores various types of information and a hard disk drive 7005. The devices 7001 to 7005 are connected to a bus 7006.

The hard disk drive 7005 stores the application management program having the same functions as these of the processing units such as the application determining unit 231, the usage specifying unit 232, and the input-output unit 233 illustrated in the embodiments. The hard disk drive 7005 also stores the configuration DB 221 and the application condition DB 222. The hard disk drive 7005 stores various types of data for implementing the application management program.

The processor 7001 perform various types of processing by reading each program stored in the hard disk drive 7005 and loading it into the RAM 7004. The programs allows the computer 7000 to function as the application determining unit 231, the usage specifying unit 232, and the input-output unit 233 illustrated in the embodiments. The programs are not necessarily stored in the hard disk drive 7005. For example, it may be configured that the computer 7000 reads the program stored in a computer 7000-readable storage medium and executes the program.

According to one aspect of the present invention, it is possible to suppress an omission of application of an update program to the data center.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An application management device comprising:
a memory that stores therein application conditions for defining a condition of whether an update program is to be applied to a data center; and
a processor that is connected to the memory, wherein the processor executes a process including:
acquiring information for an update program from a control center that manages failures in a plurality of data centers including the data center; and
controlling the application of the update program to the data center based on the acquired information for the update program and the stored application conditions.

2. The application management device according to claim 1, wherein, when a first file which is an application target of the update program is not used in the data center, and when a second file which is an application target of the update program is used in other data center that provides a service to a user same as a user of the data center, the controlling applies the update program to the data center.

3. The application management device according to claim 1, wherein
the memory stores information for the update program and information for a related update program, in which a file same as a target file which is an application target of the update program or a cooperative file cooperating with the target file is set as an application target, in accordance with each other,
the controlling applies, when the related update program is already applied to the data center, the update program to the data center, and controls the application of the update program to the data center based on the application conditions when the information for the related update program is not stored in the memory or when the related update program is not applied to the data center.

4. The application management device according to claim 3, wherein
the memory further stores information indicating that the update program and the related update program are simultaneously applied, and
the controlling simultaneously applies, even when the related update program is not applied to the data center, the update program and the related update program to the data center.

5. An application management method comprising:
referring to a memory that stores therein application conditions for defining a condition of whether an update program is to be applied to a data center by a processor;
acquiring information for an update program from a control center that manages failures in a plurality of data centers including the data center by the processor; and
controlling the application of the update program to the data center based on the acquired information for the update program and the stored application conditions by the processor.

6. A non-transitory computer-readable recording medium having stored therein a program that causes a computer to execute a process comprising:
referring to a memory that stores therein application conditions for defining a condition of whether an update program is to be applied to a data center;
acquiring information for an update program from a control center that manages failures in a plurality of data centers including the data center; and
controlling the application of the update program to the data center based on the acquired information for the update program and the stored application conditions.
